(19) United States
(12) Patent Application Publication
(10) Pub. No.: US 2026/0225067 A1
(43) Pub. Date: Aug. 6, 2026

(54) THERMALLY STABLE OXYGEN STORAGE MATERIAL (OSM) AND METHOD OF MAKING THE SAME

(71) Applicant: Pacific Industrial Development Corporation, Ann Arbor, MI (US)

(72) Inventors: Geng Zhang, Utsunomiya (JP); Anatoly Bortun, Ypsilanti, MI (US); Mila Bortun, Ypsilanti, MI (US); Benjamin Brown, Riverview, MI (US); Yunkui Li, Ann Arbor, MI (US); David Shepard, Canton, MI (US); Jeffery Lachapelle, Northville, MI (US)

(21) Appl. No.: 19/157,419

(22) PCT Filed: Mar. 7, 2024
(86) PCT No.: PCT/US2024/018798

§ 371 Date: Aug. 18, 2025

Related U.S. Application Data
(60) Provisional application No. 63/453,196, filed on Mar. 20, 2023.

(51) Int. Cl. B01J 20/08; B01J 20/02; B01J 20/28; B01J 20/30

(52) U.S. Cl. CPC B01J 20/08; B01J 20/0207; B01J 20/0211; B01J 20/28059; B01J 20/3078; B01J 2220/42; B01J 2220/4806

(57) ABSTRACT

An oxygen storage material (OSM) that includes zirconium oxide, aluminum oxide, cerium oxide, and an oxide of at least one rare earth metal other than cerium is provided. This oxygen storage material remains thermally stable after ageing at 1, 100° C. for at least 6 hours without the occurrence of any phase segregation and/or disproportionation.

### FIELD

This disclosure generally relates to metal oxide-based materials used as oxygen sensors, in solid oxide fuel cells, as catalysts, or in other applications that require oxygen storage, fast oxygen mobility, and/or conductivity.

### BACKGROUND

The statements in this section merely provide background information related to the present disclosure and may not constitute prior art.

In a three-way-conversion (TWC) catalyst or a four-way catalyst, cerium-zirconium oxide materials are widely used as oxygen storage materials (OSM or OSMs). In order to be successful in this application, an OSM needs to exhibit a high oxygen storage capacity, a high resistance to sintering over a broad temperature range, e.g., up to 1150° C., develop mesoporosity in order to exhibit effective mass transport properties, and provide compatibility with the incorporation of precious metals. Facile oxygen mobility is an important requirement for such a material because both oxygen release and re-adsorption during rapid environmental changes that may occur in the exhaust gas of a vehicle is necessary in order to prevent CO and/or HC breakthrough, especially during periods of acceleration.

The mobility of oxygen in an OSM depends on the interaction of multiple factors, such as oxide composition including the type and amount of rare earth dopants that are present, the crystalline phase (e.g., tetragonal, cubic, pyrochlore, etc.), surface area, porosity, and crystallite size. Extensive research regarding oxygen mobility in oxygen storage materials conducted over the past several decades has resulted in the development of materials that allow efficient operation of catalysts in a temperature range of 300 to 600° C. An OSM having a high oxygen storage capacity allows for a reduced amount of the OSM to be used, e.g., thereby, minimizing the thickness of the OSM layer required, reduces backpressure, and lowers the weight and cost associated with a vehicle's catalytic converter.

However, new stringent requirements regarding the emission levels for CO, NOₓ, HC, and soot has made it necessary to search for new oxygen storage materials (OSM) that exhibit high oxygen storage capacity and enhanced reducibility, long-term thermal stability, and a facile nature for both the reduction of CeO₂ and the mobility of oxygen within the material's lattice structure. The development of such new OSMs is important not only for catalyst applications, but also for use as electrolytes in solid oxide fuel cells (SOFCs) in which high conductivity at low temperatures is also required.

### SUMMARY

The present disclosure relates generally to an oxygen storage material (OSM) that comprises zirconium oxide, aluminum oxide, cerium oxide, and an oxide of at least one rare earth metal other than cerium. The OSM remains thermally stable after ageing at 1,100° C. for at least 6 hours without any phase segregation and/or disproportionation.

The OSM may have a CeO₂/ZrO₂ molar ratio that is in the range of 0.20 to 1.50 when the at least one rare earth metal includes yttrium or when yttrium is not present, the ratio is in the range of 0.40 to 1.50. The OSM may have an aluminum oxide (Al₂O₃) content that is not higher than 40 wt. % relative to the overall mass of the OSM. The at least one rare earth metal oxide other than CeO₂ in the OSM may be present in an amount up to 10 wt. % relative to the overall mass of the OSM. The OSM may have an yttrium oxide (Y₂O₃) content that is at least 0.5 wt. % relative to the overall mass of the OSM. The OSM may have an CeO₂/ZrO₂ molar ratio that is in the range of 0.35 to 1.0 when the at least one rare earth metal includes yttrium or when yttrium is not present the ratio may be in the range of 0.40 to 1.0.

According to another aspect of the present disclosure, the oxygen storage material may have a specific surface area after ageing at 1,000° C. for 6 hours that is not less than 50 m²/g. Alternatively, the OSM may have a specific surface area after ageing at 1,100° C. for 6 hours that is not less than 25 m²/g. The OSM remains thermally stable after ageing in air at 1,200° C. without any phase segregation and/or disproportionation when the at least one rare earth metal includes yttrium. The OSM exhibits an oxygen storage capacity (OSC) that is not less than 85% of theoretical OSC.

According to yet another aspect of the present disclosure, a method of making a thermally stable oxygen storage material (OSM) is provided. This method comprises the steps of:
(a) Preparing an acidic solution containing polymerized zirconium oligomers;
(b) Mixing an alumina source with the acidic solution containing the polymerized zirconium oligomers to form a mixture;
(c) Mixing a complexing agent into the mixture;
(d) Allowing the mixture to form a zirconium-aluminum-based precursor;
(e) Adding a base to the zirconium-aluminum-based precursor in order to neutralize the zirconium-aluminum-based precursor and form a zirconium-aluminum-based hydrous oxide slurry;
(f) Mixing the zirconium-aluminum-based hydrous oxide slurry with an acidic solution containing cerium and at least one rare earth metal other than cerium to form a polyvalent metal containing slurry;
(g) Ageing the polyvalent metal containing slurry at a pH that is higher than 10 in order to allow the formation of a mixed hydrous oxide precipitate;
(h) Washing the mixed hydrous oxide precipitate from anionic and/or cationic admixtures;
(i) Drying the washed mixed hydrous oxide precipitate; and
(j) Calcining the dry mixed hydrous oxide precipitate to form the oxygen storage material (OSM).
   The OSM formed by this method is thermally stable after ageing at 1,100° C. for at least 6 hours without the occurrence of any phase segregation and/or disproportionation.

In this method, the at least one rare earth metal other than cerium may include yttrium. The polymerized zirconium oligomers may comprise zirconium octamers in an amount that ranges from 30% to 100% by mass relative to the mass of the polymerized zirconium oligomers. The polymerized zirconium oligomers generally do not contain any zirconia sol particles. The base may be an alkali metal hydroxide and/or aqueous ammonia.

The aluminum source may contain one or more selected from the group consisting of dispersible aluminum hydroxide, dispersible Boehmite, aluminum oxide, aluminum Keggin-type ion nanoclusters, and combinations thereof. The amount of the aluminum Keggin-type ion nanoclusters, when present, may not be less than 25 wt. % relative to the total aluminum content of the aluminum source.

The complexing agent may be selected from the group consisting of a sulfate, a persulfate, an oxalate, a succinate and combinations thereof. The amount of the complexing agent added to the zirconium-aluminum acidic mixture is typically in the range of 0.4 to 1.2 moles per mole of zirconium.

The acidic solution containing the polymerized zirconium oligomers and the acidic solution containing the cerium and the at least one rare earth metal other than cerium may be formed using water-soluble compounds of zirconium, cerium and at least one rare earth metal other than cerium in the form of nitrates, chlorides, sulfates, acetates, or a combination thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings.

FIG. 1 is flowchart describing a method of preparing a thermally stable oxygen storage material (OSM) according to the teachings of the present disclosure.

FIG. 2A and FIG. 2B are graphical representations of x-ray diffraction (XRD) spectra measured for a thermally stable OSM prepared according to the teachings of the present disclosure after being thermally aged for 6 hours at 1,100° C. and 1,200° C., respectively.

FIG. 3A and FIG. 3B are graphical representations of x-ray diffraction (XRD) spectra measured for another thermally stable OSM prepared according to the teachings of the present disclosure after being thermally aged for 6 hours at 1,100° C. and 1,200° C., respectively.

FIG. 4A and FIG. 4B are graphical representations of x-ray diffraction (XRD) spectra measured for yet another thermally stable OSM prepared according to the teachings of the present disclosure after being thermally aged for 6 hours at 1,100° C. and 1,200° C., respectively.

FIG. 5A and FIG. 5B are graphical representations of x-ray diffraction (XRD) spectra measured for still another thermally stable OSM prepared according to the teachings of the present disclosure after being thermally aged for 6 hours at 1,100° C. and 1,200° C., respectively.

FIG. 6A and FIG. 6B are graphical representations of x-ray diffraction (XRD) spectra measured for a comparative reference OSM after being thermally aged for 6 hours at 1,100° C. and 1,200° C., respectively.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. For example, the oxygen storage material (OSM) made and used according to the teachings contained herein is described throughout the present disclosure in conjunction with a three-way catalyst (TWC) used to reduce vehicle emission gases in order to more fully illustrate the composition and the use thereof. The incorporation and use of such OSM in other catalysts for removing HC, CO, NOₓ, and soot from gasoline or diesel engines, diesel oxidation catalysts, and other oxidation catalysts, or in other applications, such as oxygen sensors or electrolytes used in solid oxide fuel cells (SOFCs) is contemplated to be within the scope of the present disclosure. It should be understood that throughout the description, corresponding reference numerals indicate like or corresponding parts and features.

The present disclosure generally provides an oxygen storage material (OSM) that remains thermally stable after ageing at 1,100° C. without any phase segregation and/or disproportionation. The OSM may comprise, consist of, or consist essentially of oxides of zirconium oxide, aluminum oxide, cerium oxide, and an oxide of at least one rare earth metal other than cerium. The OSM material may comprise cerium oxide and zirconium oxide, such that the material exhibits a molar ratio of cerium oxide to zirconium oxide (CeO₂:ZrO₂) that is between about 0.20 and about 1.50; alternatively, 0.35 to 1.00, provided that at least one rare earth metal present in the composition includes yttrium. When yttrium is not present, the CeO₂:ZrO₂ molar ratio is in the range of 0.40 to 1.50; alternatively, 0.40 to 1.00.

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one rare earth metal”, “one or more rare earth metals”, and “rare earth metal(s)” may be used interchangeably and are intended to have the same meaning.

In addition, the use of abbreviations, such as OSM or OSMs are used interchangeably herein. These abbreviations are intended to impart the same meaning no matter if reference is being made to a single oxygen storage material or a plurality of oxygen storage materials.

For the purpose of this disclosure the terms “about” and “substantially” are used herein with respect to measurable values and ranges due to expected variations known to those skilled in the art (e.g., limitations and variability in measurements).

The oxygen storage material (OSM) has an aluminum oxide content (Al₂O₃) that is not higher than 40 wt. % relative to the overall mass of the OSM. When desirable, the OSM may have an aluminum oxide content that ranges from about 30% to 40% by weight; alternatively, between about 30 wt. % and about 35 wt. %; alternatively, about 30 wt. %, relative to the overall weight of the OSM.

According to another aspect of the present disclosure, the at least one rare earth metal oxide other than cerium oxide is present in the oxygen storage material (OSM) in an amount that is up to 15 wt. % relative to the overall mass of the OSM; alternatively, up to 10 wt. %. Alternatively, the at least one rare earth metal oxide other than CeO₂ is in the range of about 5 wt. % to 11 wt. %; alternatively, about 7 wt. % to about 10 wt. %; alternatively, about 7.5 wt. %, relative to the overall mass of the OSM.

When yttrium oxide is present as a rare earth metal oxide other than cerium oxide in the OSM, the yttrium oxide (Y₂O₃) content is at least 0.50 wt. %; alternatively, between 1 wt. % and 5 wt. %; alternatively, between 2 wt. % and 3 wt. %; alternatively, up to 5 wt. %

The cerium oxide content in the oxygen storage material (OSM) may range from 15% to 35% by weight; alternatively, between about 20 wt. % to about 30 wt. %; alternatively, from about 22 wt. % to about 29 wt. % relative to the overall mass of the OSM.

The zirconium oxide content in the OSM may range from about 25 wt. % to about 50 wt. %; alternatively, about 30 wt. % to about 45 wt. %; alternatively, about 33 wt. % to about 42 wt. % relative to the overall mass of the OSM.

For the purpose of this disclosure, the term “weight” refers to a mass value having the units of grams, kilograms, and the like. Further, the recitations of numerical ranges by endpoints include the endpoints and all numbers within that numerical range. For example, an amount ranging from 40% by weight to 60% by weight (also written as 40 wt. % to 60 wt. %) includes concentrations of 40% by weight, 60% by weight, and all concentrations there between (e.g., 40.1%, 41%, 45%, 50%, 52.5%, 55%, 59%, etc.).

According to another aspect of the present disclosure, the at least one rare earth metal present in the oxygen storage material (OSM) other than cerium (Ce) may include dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), yttrium (Y), or mixtures thereof. Alternatively, the rare earth metal present in the OSM other than cerium is selected from the group of lanthanum, neodymium, praseodymium, yttrium, or a combination of thereof. The amount of rare earth metals present in the OSM is sufficient for stabilization of the crystalline lattice of the material.

The oxygen mobility exhibited by the oxygen storage material is due to a combination of the facile nature of Ce⁴⁺⇄Ce³⁺ oxidation/reduction reactions that occur in a typical exhaust gas mixture and the presence of aliovalent ions (La³⁺, Nd³⁺, Y³⁺, etc.) in the crystal lattice structure of the OSM. The presence of these aliovalent ions are responsible for formation of oxygen vacancies in the lattice structure, which enable oxygen migration from the bulk of crystallites to the surface along with the reverse process.

Cerium oxide has the ability to form non-stoichiometric CeO₂₋ₓ surface defect sites, which lead to oxygen vacancies and the formation of active surface oxygen species. Zirconium oxide exhibits a similar effect. When both cerium oxide and zirconium oxide are combined to form the OSM this effect becomes enhanced. In addition to surface oxygen mobility, the zirconium oxide also causes an increase in the mobility of lattice oxygen species due to an increase in the reducibility of Ce⁴⁺ to Ce³⁺. The introduction of zirconium oxide in the cubic cerium oxide lattice increases the generation of defects in the cerium-zirconium oxide-based oxygen storage material, which promotes the mobility of lattice oxygen, thereby allowing the redox reaction that takes place at the surface to occur in the interior of the OSM as well. Zirconium oxide also has the capability to stabilize the crystalline structure during high temperature use.

The oxygen storage material (OSM) may exhibit a specific surface area (SSA) after ageing at 1,000° C. for 6 hours that is not less than 50 m²/g; alternatively, the SAA ranges from 50 m²/g to about 75 m²/g; alternatively, from 50 m²/g to about 60 m²/g. Upon ageing at 1,100° C. for 6 hours the specific surface area is not less than 25 m²/g; alternatively, the SSA ranges from about 25 m²/g to 49 m²/g; alternatively, the SAA ranges from 25 m²/g to about 45 m²/g alternatively, the SAA ranges from 25 m²/g to about 40 m²/g. After aging for 6 hours at 1,200° C., the SSA is not less than 10 m²/g; alternatively, the specific surface area ranges from about 10 m²/g to about 24 m²/g; alternatively, the SAA ranges from 10 m²/g to about 20 m²/g; alternatively, from 10 m²/g to about 16 m²/g.

The oxygen storage material (OSM) may exhibit a pore volume (PV) after ageing at 1,000° C. for 6 hours that is not less than 0.400 cm³/g; alternatively, the PV ranges from 0.420 cm³/g to about 0.600 cm³/g; alternatively, from 0.430 cm³/g to about 0.550 cm³/g. Upon ageing at 1,100° C. for 6 hours the pore volume is not less than 0.200 cm³/g; alternatively, the PV ranges from about 0.210 cm³/g to 0.450 cm³/g; alternatively, the PV ranges from 0.220 cm³/g to about 0.400 cm³/g alternatively, the PV ranges from 0.225 cm³/g to about 0.385 cm³/g. After aging for 6 hours at 1,200° C., the PV is not less than 0.075 cm³/g; alternatively, the pore volume ranges from about 0.080 cm³/g to about 0.120 cm³/g; alternatively, the PV ranges from 0.080 cm³/g to about 0.1150 cm³/g.

The oxygen storage material (OSM) formed according to the teachings of the present disclosure remains thermally stable after ageing at 1,100° C. for at least 6 hours without any phase segregation and/or disproportionation. When the at least one rare earth metal oxide other than cerium oxide includes yttrium oxide, the thermal stability becomes further enhanced, such that phase segregation and/or disproportionation is either not present or is just beginning after ageing at 1,200° C.

According to another aspect of the present disclosure, the OSM of the present disclosure exhibits a high oxidation-reduction activity. The OSMs are capable of incorporating oxygen from an oxidation atmosphere and supplying oxygen in a reducing atmosphere. This property is called the oxygen storage capacity (OSC) of the material. More specifically, oxygen storage capacity may be defined as the amount of oxygen per OSM weight stored in and released from the OSM on a time scale of seconds to minutes. The oxygen storage capacity (OSC) of the oxygen storage material of the present disclosure is at least 80% of the theoretical OSC for a given material composition; alternatively, the OSC of the OSM is not less than 85% of the theoretical OSC; alternatively, the OSC is 90% or higher relative to the theoretical oxygen storage capacity.

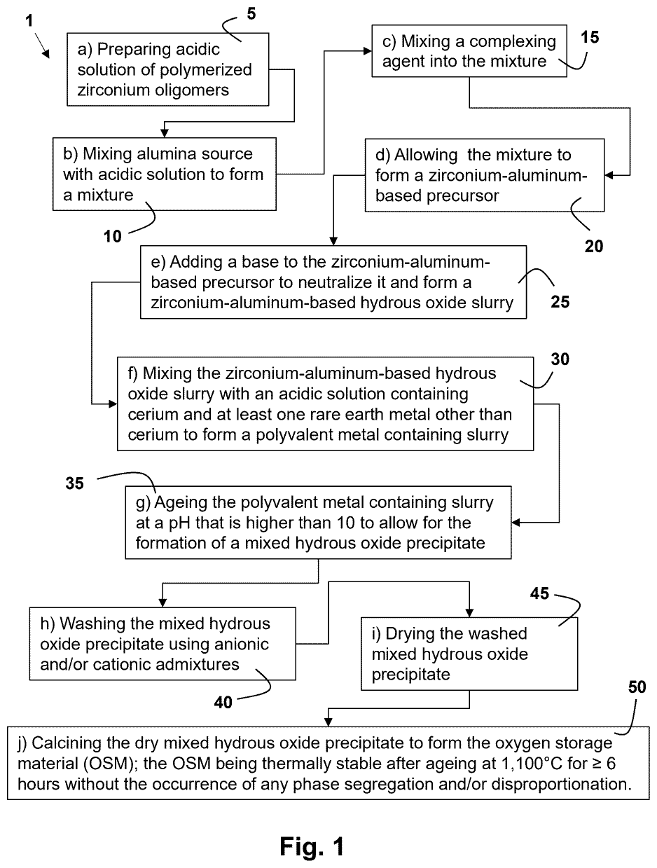

According to yet another aspect of the present disclosure, a method of making the thermally stable oxygen material (OSM) described above and as further defined herein is provided. Referring to FIG. 1, this method 1 generally comprises the steps of:
(a) Preparing 5 an acidic solution containing polymerized zirconium oligomers;
(b) Mixing 10 an alumina source with the acidic solution containing the polymerized zirconium oligomers to form a mixture;
(c) Mixing 15 a complexing agent into the mixture;
(d) Allowing 20 the mixture to form a zirconium-aluminum-based precursor;
(e) Adding 25 a base to the zirconium-aluminum-based precursor in order to neutralize the zirconium-aluminum-based precursor and form a zirconium-aluminum-based hydrous oxide slurry;
(f) Mixing 30 the zirconium-aluminum-based hydrous oxide slurry with an acidic solution containing cerium and at least one rare earth metal other than cerium to form a polyvalent metal containing slurry;
(g) Ageing 35 the polyvalent metal containing slurry at a pH that is higher than 10 in order to allow the formation of a mixed hydrous oxide precipitate;
(h) Washing 40 the mixed hydrous oxide precipitate from anionic and/or cationic admixtures;
(i) Drying 45 the washed mixed hydrous oxide precipitate; and
(j) Calcining 50 the dry mixed hydrous oxide precipitate to form the oxygen storage material (OSM); wherein the OSM is thermally stable after ageing at 1,100° C. without the occurrence of any phase segregation and/or disproportionation.

Referring now to specific aspects of the method 1 shown in FIG. 1, the acidic solution that is initially prepared 5 to comprise a solution containing polymerized zirconium oligomers includes such oligomers in an amount ranging from about 30% to about 100% by weight of the total weight of the solution. Alternatively, the polymerized zirconium oligomers are present in an amount ranging from 35 wt. % to about 90 wt. %; alternatively, 40 wt. % to about 80 wt. %; alternatively, greater than 30% by weight; alternatively, greater than 50% by weight; alternatively, greater than 75% by weight.

The acidic solution of polymerized zirconium oligomers may be prepared 5 by any known method. These methods may include, without limitation, partial removal of any charge balancing counter-anion by electrodialysis; anionic extraction with aliphatic amines or by the treatment with an anion exchange resin; dissolution of freshly made zirconium hydroxide in an acid; or using a red-ox reaction with a chloride ion form a zirconium oxychloride solution and H₂O₂ in acidic media. The use of polymerized zirconium species as a zirconium source results in changing starting blocks in zirconia nuclei formation from zirconium tetramer units in the case of zirconium oxychloride to zirconium oligomer species (e.g., octamers) to a different extent, which increases average nuclei size and alters their morphology. When desirable, the polymerized zirconium oligomers may comprise zirconium octamers in an amount ranging from about 30 to 100%; alternatively, in an amount ranging from about 40% to about 90% relative to the overall mass of the polymerized zirconium oligomers. The polymerized zirconium oligomers do not contain zirconia sol particles.

Still referring to FIG. 1, the source of alumina that is mixed 10 with the acidic solution of polymerized zirconium oligomers contains one or more selected from the group consisting of dispersible aluminum hydroxide, dispersible Boehmite, aluminum oxide, aluminum Keggin-type ion nanoclusters, and combinations thereof. Alternatively, the source of alumina includes aluminum Keggin-type ion nanoclusters in an amount that is not less than 25 wt. % relative to the total aluminum content of the alumina source; alternatively, the amount of aluminum Keggin-type ion nanoclusters present in the alumina source ranges from 25 wt. % to about 35 wt. %.

Dispersible Boehmite is a powder in which the Boehmite particles form stable nan-sized dispersions in a desired or selected fluid, such as water or an organic solvent. Keggin-type aluminum ion nanoclusters, which are also known as polyaluminum (oxy)hydroxide nanoclusters, may comprise a variety of isomers and contain different surface functional groups. One example of a Keggin-type aluminum ion nanocluster among many possible examples includes, without limitation, [AlO₄Al₁₂(OH)₂₄(H₂O)₁₂]⁷⁺(Al₁₃). This Al₁₃ Keggin-type cluster generally comprises a tetrahedrally-coordinated Al(O)₄ unit surrounded by twelve Al octahedra, held together within four [Al₃(μ₂-OH)₆(H₂O)₃]trimers. The Al₁₃ nanocluster also may form larger nanoclusters, such as for example, [Al₂(O)₈Al₂₄(OH)₅₀(H₂O)₂₀]¹²⁺ (Al₂₆), [Al₃₀(O)₈(OH)₅₆(H₂O)₂₄]¹⁸⁺(Al₃₀), and [Al₃₂(O)₈(OH)₆₀(H₂O)₂₈(SO₄)₂]¹⁶⁺(Al₃₂) through condensation reactions and the addition of monomeric aluminum linker molecules.

Another aspect of the method 1 includes adding 15 a complexing agent to the reaction mixture. This complexing agent may comprise anions that have an affinity towards zirconium. The complexing agent may be selected from the group comprising, consisting of, or consisting essentially of a sulfate, a persulfate, an oxalate, a succinate, and combinations thereof. The complexing agent is chosen such that it is adsorbed onto the surface of the zirconium oligomers, thereby, occupying and protecting reactive sites from participation in further polymerization reactions. The amount of the complexing agent added 15 to the reaction mixture may be in the range of 0.4 to 1.2 moles per mole of zirconium present in the reaction mixture. Alternatively, the amount of the complexing agent may be in the range of 0.4 and 1.0 moles per mole of zirconium; alternatively, between 0.50 and 0.80 moles per mole of zirconium. As a result, during the neutralization reaction 25 (e.g., addition of a base) the complexing agent slows down the formation of zirconium hydroxide primary particles due to the competition arising from hydroxyl ions and the effects on their size, morphology, and way of packing (e.g., enabling formation of loosely assembled secondary aggregates).

Still referring to FIG. 1, the preparation 5 of the acidic solution containing the polymerized zirconium oligomers and the acidic solution containing cerium and at least one rare earth metal other than cerium, which is subsequently mixed 30 with the zirconium-aluminum-based precursor, are formed using water-soluble compounds of zirconium, cerium, and at least one rare earth metal other than cerium. These water-soluble compounds may be in the form of nitrates, chlorides, sulfates, acetates, or a combination thereof.

In addition, the base added 25 to form a zirconium-aluminum-based hydrous oxide slurry may be chosen from alkali metal hydroxides, hydrous ammonia, tetraalkylammonium hydroxide, or a combination thereof. Alternatively, the base is an alkali metal hydroxide and/or aqueous ammonia.

The following specific examples are given to illustrate the oxygen storage materials (OSM) formed according to the teachings of the present disclosure and the method of forming these materials, as well as the properties thereof and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

Test Methodoloqy—The specific surface area (SSA) and pore volume (PV) for the oxygen storage materials are measured according to conventional Brunauer-Emmett-Teller (BET) and Barrett-Joyner-Halenda (BHJ) analysis methods using a TriStar Micromeritics Inc. analyzer.

The crystalline phase or framework structure of a zeolite may be characterized by x-ray diffraction (XRD) data. However, the XRD measurement may be influenced by a variety of factors, such as the growth direction of the zeolite; the ratio of constituent elements; the presence of an adsorbed substance, defects, or the like; and deviation in the intensity ratio or positioning of each peak in the XRD spectrum. Therefore, a deviation of 10% or less; alternatively, 5% or less; alternatively, 1% or less in the numerical value measured for each parameter of the framework structure for a zeolite is within expected tolerance

The redox activity of the aged OSM is tested using a conventional TPR-H₂ method. TPR-H₂ provides a measurement capable of indicating the amount of active oxygen species and the steps involved in the reduction process of the metal oxides. A Micromeritics Autochem 2920 II instrument is used to test temperature programed reduction (TPR) in the temperature range from 25° C. to 900° C. with a temperature ramp 10° C./min and a constant 90% Ar/10% H₂ gas flow rate of 5 cm³/min.

Example 1—A thermally stable OSM having the composition of (30% Al₂O₃-22% CeO₂-37.5% ZrO₂-5% La₂O₃-3% Y₂O₃-2.5% Nd₂O₃) and a CeO₂/ZrO₂ molar ratio of 0.42 is prepared according to the following procedure.

A zirconium-containing solution is prepared by dissolving 50.5 grams of ZrOCl₂*8H₂O crystals in 400 grams of deionized (DI) water. A total of 32.4 grams of a 15% NaOH solution is added to the zirconium-containing solution and mixed until a clear solution of a polymerized zirconium precursor is formed. Then, 15.0 grams of an alumina slurry, consisting of Boehmite and Keggin-type aluminum nanoclusters in a ratio 4:1, is added to the zirconium-containing solution. Then, a total of 64.2 grams of a 16.7% Na₂SO₄ solution is added to the zirconium-containing solution in order to form a zirconium-alumina based precursor. A total of 141 grams of a 7.8% Ce(NO₃)₃ solution, 16.1 grams of a 15.5% La(NO₃)₃ solution, 7.6 grams of a 19.75% Y(NO₃)₃ solution, and 5.2 g of a 24.1% Nd(NO₃)₃ solution is added to the zirconium-alumina based precursor and thoroughly mixed to form a slurry. Finally, a 25% NaOH solution is slowly added to the slurry until the pH reaches 13. The slurry is allowed to age at a pH maintained above 10 until a precipitate forms. The precipitate that forms is filtered using a Buchner filter funnel and washed with deionized (DI) water to remove any excess cations and/or anions. The resulting precipitate, e.g., wet cake, is dried in an electric oven at 130° C. and then calcined at 700° C. for 2 hours to form a powder comprising the oxygen storage material (OSM).

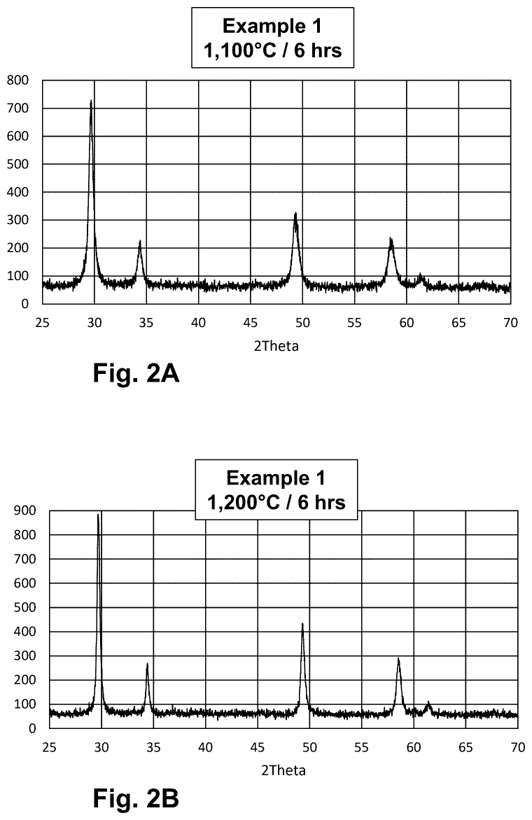

The calcined OSM powder is additionally aged at 1,000° C., 1,100° C., and 1,200° C. for 6 hours at each temperature. There is no indication of the presence of any alumina phase or the occurrence of any disproportionation in the OSM after being aged at any of the predetermined temperatures indicated above. The x-ray diffraction (XRD) spectra measured for the OSM after ageing at 1,100° C./6 hours and 1,200° C./6 hours is provided in FIGS. 2A and 2B, respectively. These spectra as shown in FIGS. 2A and 2B demonstrate that after exposure to such thermal ageing conditions, the OSM remains phase stable.

A TPR-H₂ profile for this oxygen storage material was measured and found that the OSM exhibits greater than 85% or more of the theoretical oxygen storage capacity (OSC) available. The specific surface area (SSA) and pore volume (PV) of the calcined oxygen storage materials were also measured after ageing at each predetermined temperature with a summary provided in Table 1.

TABLE 1

| | SSA | PV |
|---|---|---|
| | (m²/g) | (cm³/g) |
| 1,000° C./6 hrs | 52.4 | 0.528 |
| 1,100° C./6 hrs | 35.2 | 0.382 |
| 1,200° C./6 hrs | 12.1 | 0.114 |

This example demonstrates that the OSM formed according to the teachings of the present disclosure remains thermally stable without any phase segregation and/or disproportionation occurring after ageing at 1,100° C. In addition, the inclusion of yttrium oxide in this composition further enhances the thermal stability of the OSM in that the no phase segregation and/or disproportionation occurs even after ageing at 1,200° C. for at least 6 hours.

Example 2—A thermally stable OSM having the composition of (30% Al₂O₃-22% CeO₂-40.5% ZrO₂-4% La₂O₃-2.5% Y₂O₃-1% Nd₂O₃) and a CeO₂/ZrO₂ molar ratio 0.39 is prepared according to the following procedure.

A zirconium-containing solution is prepared by dissolving 54.6 grams of ZrOCl₂*8H₂O crystals in 460 grams of deionized (DI) water. A total of 35.0 grams of a 15% NaOH solution is added to zirconium-containing solution and mixed until a clear solution of a polymerized zirconium precursor is formed. After that 15.0 grams of an alumina slurry, consisting of a Boehmite and Keggin-type aluminum nanoclusters in a ratio 4:1, is added to the zirconium-containing solution. Then, a total of 69.4 grams of a 16.7% Na₂SO₄ solution is added to the zirconium-containing solution to form a zirconium-alumina based precursor. A total of 125.9 grams of an 8.7% Ce(NO₃)₃ solution, 12.9 grams of a 15.5% La(NO₃)₃ solution, 6.3 grams of a 19.75% Y(NO₃)₃ solution, and 2.1 grams of a 24.1% Nd(NO₃)₃ solution is added to zirconium-alumina based precursor and thoroughly mixed. Finally, a 25% NaOH solution is slowly added to the slurry until the pH reaches 13. The slurry is allowed to age at a pH maintained above 10 until a precipitate forms. The precipitate that forms is filtered using a Buchner filter funnel and washed with deionized (DI) water to remove any excess cations and/or anions. The resulting precipitate, e.g., wet cake, is dried in an electric oven at 130° C. and then calcined at 700° C. for 2 hours to form a powder comprising the oxygen storage material (OSM).

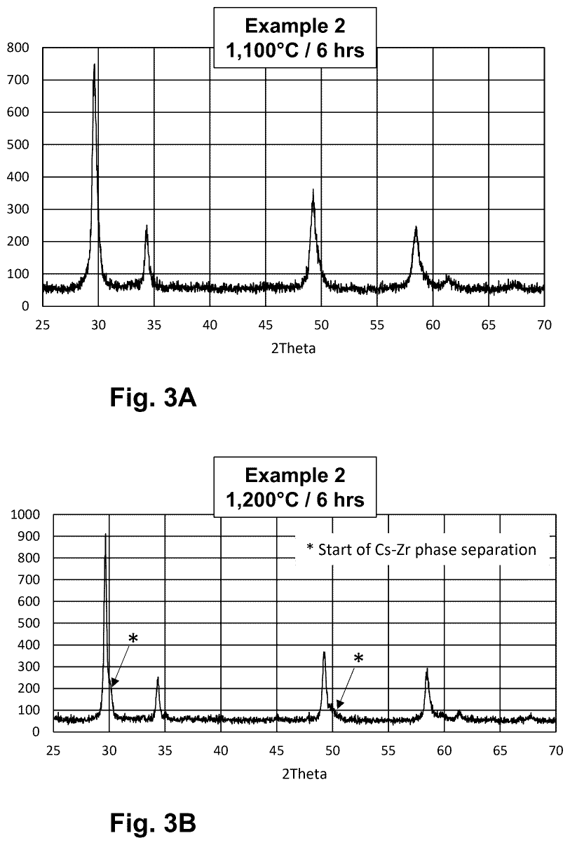

The calcined OSM powder is additionally aged at 1,000° C., 1,100° C., and 1,200° C. for 6 hours at each temperature. There is no indication of the presence of any alumina phase or the occurrence of any disproportionation in the OSM after being aged at 1,000° C. or 1,100° C. The x-ray diffraction (XRD) spectra measured for the OSM after ageing at 1,100° C./6 hours and 1,200° C./6 hours are provided in FIGS. 3A and 3B, respectively. The XRD spectrum as shown in FIG. 3A demonstrates that after exposure to 1,100° C. for 6 hours, the OSM remains phase stable. There is no indication of the presence of any alumina phase in the OSM after ageing at 1,100° C. or 1,200° C. However, the formation of a shoulder in peaks located at a 2θ angle of 29° and 49° after ageing at 1,200° C. for 6 hours indicates the start of cesium-zirconium phase segregation in the OSM.

A TPR-H₂ profile for this oxygen storage material was measured and found that the OSM exhibits greater than 85% or more of the theoretical oxygen storage capacity (OSC) available. The specific surface area (SSA) and pore volume (PV) of the calcined oxygen storage materials were also measured after ageing at each predetermined temperature with a summary provided in Table 2.

TABLE 2

| | SSA | PV |
|---|---|---|
| | (m2/g) | (cm³/g) |
| 1,000° C./6 hrs | 51.9 | 0.449 |
| 1,100° C./6 hrs | 32.2 | 0.225 |
| 1,200° C./6 hrs | 11.0 | 0.101 |

This example further demonstrates that the OSM formed according to the teachings of the present disclosure remains thermally stable without any phase segregation and/or disproportionation occurring after ageing at 1,100° C. In addition, the inclusion of yttrium oxide in this composition further enhances the thermal stability of the OSM in that only the initiation of phase segregation begins to occur after 6 hours of ageing at 1,200° C.

Example 3—A thermally stable OSM having the composition of (30% Al₂O₃-29% CeO₂-33.5% ZrO₂-5% La₂O₃-2.5% Y₂O₃) and a CeO₂/ZrO₂ molar ratio of 0.62 is prepared according to the following procedure.

A zirconium-containing solution is prepared by dissolving 45.1 grams of ZrOCl₂*8H₂O crystals in 380 grams of deionized (DI) water. A total of 28.9 grams of a 15% NaOH solution is added to zirconium-containing solution and mixed until a clear solution of a polymerized zirconium precursor is formed. Then, 15.0 grams of an alumina slurry, consisting of a Boehmite and Keggin-type aluminum nanoclusters in a ratio 3:1, is added to the zirconium-containing solution. The next step includes the addition of 57.4 grams of a 16.7% Na₂SO₄ solution to the zirconium-containing solution in order to form a zirconium-alumina-based precursor. A total of 157 grams of a 9.2% Ce(NO₃)₃ solution, 16.1 grams of a 15.5% La(NO₃)₃ solution, and 6.3 grams of a 19.75% Y(NO₃)₃ solution is added to zirconium-alumina-based precursor and thoroughly mixed to form a slurry. Finally, a 25% NaOH solution is slowly added to the slurry until the pH reaches 13. The slurry is allowed to age at a pH maintained above 10 until a precipitate forms. The precipitate that forms is filtered using a Buchner filter funnel and washed with deionized (DI) water to remove any excess cations and/or anions. The resulting precipitate, e.g., wet cake, is dried in an electric oven at 130° C. and then calcined at 700° C. for 2 hours.

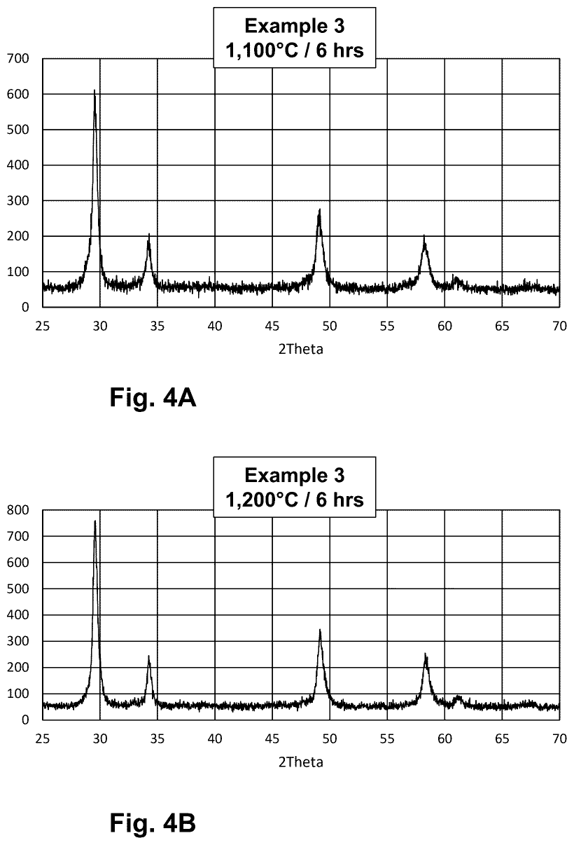

The calcined OSM powder is additionally aged at 1,000° C., 1,100° C., and 1,200° C. for 6 hours at each temperature. There is no indication of the presence of any alumina phase or the occurrence of any disproportionation in the OSM after being aged at any of the predetermined temperatures indicated above. The x-ray diffraction (XRD) spectra measured for the OSM after ageing at 1100° C. for 6 hours and 1200° C. for 6 hours is provided in FIGS. 4 and 4B, respectively. These spectra as shown in FIGS. 4A and 4B demonstrate that after exposure to such thermal ageing conditions, the OSM remains phase stable.

A TPR-H₂ profile for this oxygen storage material was measured and found that the OSM exhibits greater than 85% or more of the theoretical oxygen storage capacity (OSC) available. The specific surface area (SSA) and pore volume (PV) of the calcined oxygen storage materials were also measured after ageing at each predetermined temperature with a summary provided in Table 3.

TABLE 3

| | SSA | PV |
|---|---|---|
| | (m²/g) | (cm³/g) |
| 1,000° C./6 hrs | 50.7 | 0.431 |
| 1,100° C./6 hrs | 26.7 | 0.255 |
| 1,200° C./6 hrs | 11.4 | 0.082 |

This example demonstrates that the OSM formed according to the teachings of the present disclosure remains thermally stable without any phase segregation and/or disproportionation occurring after ageing at 1,100° C. In addition, the inclusion of yttrium oxide in this composition further enhances the thermal stability of the OSM in that the no phase segregation and/or disproportionation occurs even after ageing at 1,200° C. for at least 6 hours.

Example 4—A thermally stable OSM having the composition of (30% Al₂O₃-29% CeO₂-33.5% ZrO₂-5% La₂O₃-2.5% Pr₆O₁₁) and a CeO₂/ZrO₂ molar ratio of 0.62 is prepared according to the following procedure.

A zirconium-containing solution is prepared by dissolving 45.1 grams of ZrOCl₂*8H₂O crystals in 380 grams of deionized (DI) water. A total of 28.9 grams of a 15% NaOH solution is added to zirconium-containing solution and mixed until a clear solution of a polymerized zirconium precursor is formed. Then, 15 grams of an alumina slurry, consisting of Boehmite and Keggin-type aluminum nanoclusters in a ratio 3:1, is added to zirconium-containing solution. Then, a total of 57.4 grams of a 16.7% Na₂SO₄ solution is added to the slurry to form a zirconium-alumina based precursor. Then, 157 grams of a 9.2% Ce(NO₃)₃ solution, 16.1 grams of a 15.5% La(NO₃)₃ solution, and 6.1 grams of a 20.56% Pr(NO₃)₃ solution is added to zirconium-alumina based precursor and thoroughly mixed. Finally, a 25% NaOH solution is slowly added to the slurry until the pH reaches 13. The slurry is allowed to age at a pH maintained above 10 until a precipitate forms. The precipitate that forms is filtered using a Buchner filter funnel and washed with deionized (DI) water to remove any excess cations and/or anions. The resulting precipitate, e.g., wet cake, is dried in an electric oven at 130° C. and then calcined at 700° C. for 2 hours.

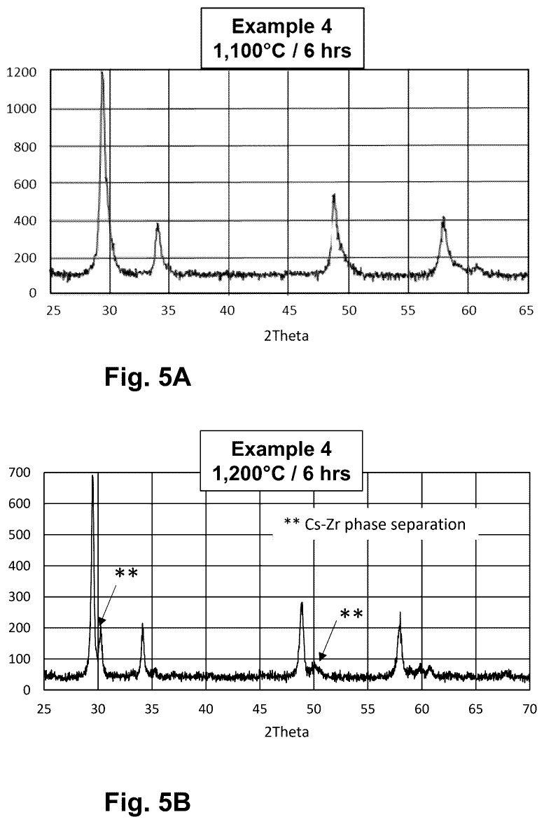

The calcined OSM powder is additionally aged at 1,000° C., 1,100° C., and 1,200° C. for 6 hours at each temperature. There is no indication of the presence of any alumina phase or the occurrence of any disproportionation in the OSM after being aged at 1000° C. for 6 hours. The x-ray diffraction (XRD) spectra measured for the OSM after ageing at 1100° C./6 hours and 1200° C./6 hours is provided in FIGS. 5A and 5B, respectively. The XRD spectrum as shown in FIG. 5A demonstrates that after exposure to 1,100° C. for 6 hours, the OSM remains phase stable. There is no indication of the presence of any other alumina phase in the OSM after ageing at 1,100° C. for 6 hours. However, the XRD spectrum as shown in FIG. 5B demonstrates that after exposure to 1,200° C. for 6 hours the start of cesium-zirconium phase segregation in the OSM is beginning to occur.

A TPR-H₂ profile for this oxygen storage material was measured and found that the OSM exhibits greater than 85% or more of the theoretical oxygen storage capacity (OSC) available. The specific surface area (SSA) and pore volume (PV) of the calcined oxygen storage materials were also measured after ageing at each predetermined temperature with a summary provided in Table 4.

TABLE 4

| | SSA | PV |
|---|---|---|
| | (m²/g) | (cm³/g) |
| 1,000° C./6 hrs | 55.4 | 0.458 |
| 1,100° C./6 hrs | 38.1 | 0.303 |
| 1,200° C./6 hrs | 15.7 | 0.115 |

This example demonstrates that the OSM formed according to the teachings of the present disclosure remains thermally stable without any phase segregation and/or disproportionation occurring after ageing at 1,100° C. In addition, the absence of yttrium oxide in this composition demonstrates the lack of thermal stability of the OSM upon ageing at 1,200° C. due to the occurrence of phase segregation and/or disproportionation occurs after 6 hours of such ageing.

Comparative Reference 1—For comparison, a reference OSM having the composition of (30% Al₂O₃-22% CeO₂-40% ZrO₂-5% La₂O₃-3% Nd₂O₃) and a CeO₂/ZrO₂ molar ratio of 0.39 is prepared according to the following procedure.

A zirconium-containing solution is prepared by dissolving 47.6 grams of zirconium basic carbonate (40 wt. % ZrO₂ equivalent) in nitric acid until formation of a clear solution of a polymerized zirconium precursor. Then, 15 grams of an alumina slurry, consisting of a Boehmite and Keggin-type aluminum nanoclusters in a ratio 4:1, is added to the zirconium-containing solution. Then, a total of 57.4 grams of a 16.7% Na₂SO₄ solution is added to the zirconium-containing solution to form a zirconium-alumina based precursor. Then, 65.0 grams of a 16.9% Ce(NO₃)₃ solution, 9.6 grams of a 26.1% La(NO₃)₃ solution, and 5.1 grams of a 29.5% Nd(NO₃)₃ solution is added to the zirconium-alumina based precursor and thoroughly mixed to form a slurry. Finally, a 25% NaOH solution is slowly added to the slurry until the pH reaches 13. The slurry is allowed to age at a pH maintained above 10 until a precipitate forms. The precipitate that forms is filtered using a Buchner filter funnel and washed with deionized (DI) water to remove any excess cations and/or anions. The resulting precipitate, e.g., wet cake, is dried in an electric oven at 130° C. and then calcined at 700° C. for 2 hours.

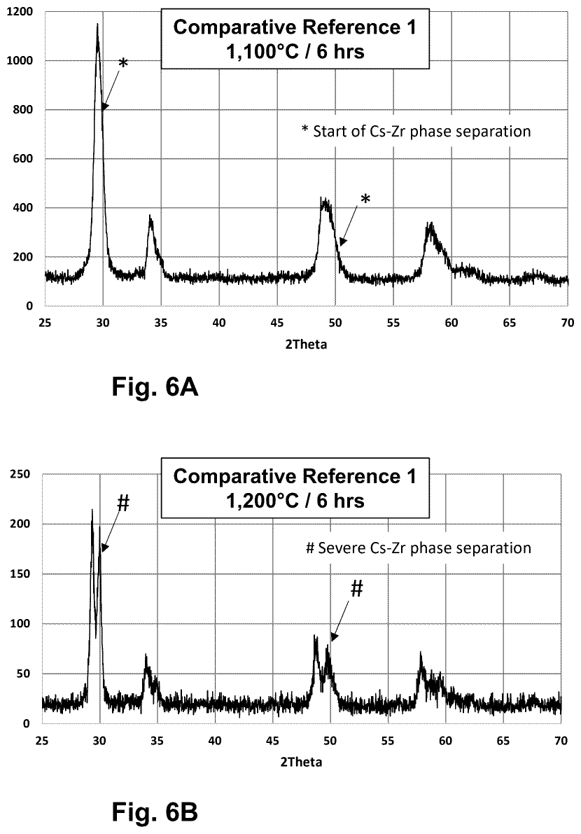

The calcined OSM powder is additionally aged at 1000° C., 1100° C., and 1200° C. for 6 hours at each temperature. There is no indication of the presence of any alumina phase or the occurrence of any disproportionation in the OSM after being aged at 1000° C. for 6 hours. The x-ray diffraction (XRD) spectra measured for the OSM after ageing at 1100° C./6 hours and 1200° C./6 hours is provided in FIGS. 6A and 6B, respectively. In FIG. 6A, the XRD spectrum exhibits signs of cesium-zirconium phase segregation in the OSM. The degree of phase separation in the OSM is observed to become even more severe after ageing at 1,200° C. for 6 hours as shown in FIG. 6B.

The specific surface area (SSA) and pore volume (PV) of the calcined oxygen storage materials are summarized in Table 5 after ageing at each predetermined temperature.

TABLE 5

| | SSA | PV |
|---|---|---|
| | (m²/g) | (cm³/g) |
| 1,000° C./6 hrs | 57.2 | 0.376 |
| 1,100° C./6 hrs | 30.1 | 0.220 |

This example demonstrates that a reference OSM, which represents a conventional oxygen storage material, is not thermally stable after ageing at 1,100° C. in that phase segregation and/or disproportionation is found to occur.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. An oxygen storage material (OSM) comprising zirconium oxide, aluminum oxide, cerium oxide, and an oxide of at least one rare earth metal other than cerium,
wherein the OSM remains thermally stable after ageing at 1,100° C. for at least 6 hours without any phase segregation and/or disproportionation.

2. The oxygen storage material according to claim 1, wherein the OSM has a CeO₂/ZrO₂ molar ratio in the range of 0.20 to 1.50 when the at least one rare earth metal includes yttrium or when yttrium is not present the ratio is in the range of 0.40 to 1.50.

3. The oxygen storage material according to claim 1, wherein the OSM has an aluminum oxide (Al₂O₃) content that is not higher than 40 wt. % relative to the overall mass of the OSM.

4. The oxygen storage material according to claim 1, wherein the OSM has an yttrium oxide (Y₂O₃) content that is at least 0.5 wt. % relative to the overall mass of the OSM.

5. The oxygen storage material according to claim 1, wherein the at least one rare earth metal oxide other than CeO₂ is present in an amount up to 10 wt. % relative to the overall mass of the OSM.

6. The oxygen storage material according to claim 1, wherein the OSM has a CeO₂/ZrO₂ molar ratio in the range of 0.35 to 1.0 when the at least one rare earth metal includes yttrium or when yttrium is not present the ratio is in the range of 0.40 to 1.0.

7. The oxygen storage material according to claim 1, wherein the OSM has a specific surface area after ageing at 1,000° C. for 6 hours that is not less than 50 m²/g.

8. The oxygen storage material according to claim 1, wherein the OSM has a specific surface area after ageing at 1,100° C. for 6 hours that is not less than 25 m²/g.

9. The oxygen storage material according to claim 1, wherein the OSM remains thermally stable after ageing in air at 1,200° C. without any phase segregation and/or disproportionation when the at least one rare earth metal includes yttrium.

10. The oxygen storage material according to claim 1, wherein OSM has an oxygen storage capacity (OSC) that is not less than 85% of theoretical OSC.

11. A method of making a thermally stable oxygen storage material (OSM), the method comprising the steps of:
(a) Preparing an acidic solution containing polymerized zirconium oligomers;
(b) Mixing an alumina source with the acidic solution containing the polymerized zirconium oligomers to form a mixture;
(c) Mixing a complexing agent into the mixture;
(d) Allowing the mixture to form a zirconium-aluminum-based precursor;
(e) Adding a base to the zirconium-aluminum-based precursor in order to neutralize the zirconium-aluminum-based precursor and form a zirconium-aluminum-based hydrous oxide slurry;
(f) Mixing the zirconium-aluminum-based hydrous oxide slurry with an acidic solution containing cerium and at least one rare earth metal other than cerium to form a polyvalent metal containing slurry;
(g) Ageing the polyvalent metal containing slurry at a pH that is higher than 10 in order to allow the formation of a mixed hydrous oxide precipitate;
(h) Washing the mixed hydrous oxide precipitate from anionic and/or cationic admixtures;
(i) Drying the washed mixed hydrous oxide precipitate; and
(j) Calcining the dry mixed hydrous oxide precipitate to form the oxygen storage material (OSM);
wherein the OSM is thermally stable after ageing at 1,100° C. for at least 6 hours without the occurrence of any phase segregation and/or disproportionation.

12. The method according to claim 11, wherein the at least one rare earth metal other than cerium includes yttrium.

13. The method according to claim 11, wherein the polymerized zirconium oligomers comprise zirconium octamers in an amount that ranges from 30% to 100% by mass relative to the mass of the polymerized zirconium oligomers.

14. The method according to claim 11, wherein the polymerized zirconium oligomers do not contain any zirconia sol particles.

15. The method according to claim 11, wherein the aluminum source contains one or more selected from the group consisting of dispersible aluminum hydroxide, dispersible Boehmite, aluminum oxide, aluminum Keggin-type ion nanoclusters, and combinations thereof.

16. The method according to claim 11, wherein the amount of the aluminum Keggin-type ion nanoclusters is not less than 25 wt. % relative to the total aluminum content of the aluminum source.

17. The method according to claim 11, wherein the complexing agent is selected from the group consisting of a sulfate, a persulfate, an oxalate, a succinate and combinations thereof.

18. The method according to claim 11, wherein the amount of the complexing agent added to the zirconium-aluminum acidic mixture is in the range of 0.4 to 1.2 moles per mole of zirconium.

19. The method according to claim 11, wherein the acidic solution containing polymerized zirconium oligomers and the acidic solution containing cerium and at least one rare earth metal other than cerium are formed using water-soluble compounds of zirconium, cerium and at least one rare earth metal other than cerium in the form of nitrates, chlorides, sulfates, acetates, or a combination thereof.

20. The method according to claim 11, wherein the base is an alkali metal hydroxide and/or aqueous ammonia.
